(19) United States
(12) Patent Application Publication
(10) Pub. No.: US 2009/0086346 A1
(43) Pub. Date: Apr. 2, 2009

(54) SIDE MIRROR ASSEMBLY FOR A MOTOR VEHICLE

(75) Inventor: Paul R. Henion, Port Huron, MI (US)

Correspondence Address: REISING, ETHINGTON, BARNES, KISSELLE, P.C., P O BOX 4390, TROY, MI, 48099-4390, US

(73) Assignee: SCHEFENACKER VISION SYSTEMS USA, INC., Marysville, MI (US)

(21) Appl. No.: 11/865,328

(22) Filed: Oct. 1, 2007

(51) Int. Cl. G02B 5/08

(52) U.S. Cl. 359/841

(57) ABSTRACT

A side mirror assembly for a motor vehicle includes a base that is fixedly secured to the motor vehicle. A structural member is secured to the base. The structural member extends between a base end and a distal end. A mirror housing defining a mirror opening is operatively connected to the structural member. A mirror is mounted within the mirror housing and exposed through the mirror opening for an operator of a motor vehicle to view rearward of the motor vehicle without turning completely around. An approach light is fixedly secured to the structural member to emit visible light downwardly therefrom.

### BACKGROUND ART

1. Field of the Invention

The invention relates to mirror assemblies for motor vehicles. More particularly, the invention relates to telescoping side mirrors having approach lights for motor vehicles.

2. Description of the Related Art

Motor vehicles are equipped with side mirrors to facilitate the operator of a motor vehicle to view spaces and objects behind the motor vehicle. As the motor vehicles get bigger, with the popularity of sport utility and cross-over vehicles, and the loads in which the motor vehicles can haul increase, the ability for the operator of the motor vehicle to view the spaces therebehind becomes increasingly difficult. Therefore, there is are several embodiments of telescoping mirror assemblies allowing the operator of the motor vehicle to view spaces behind the motor vehicle that are larger than the traditional areas that were viewable by traditional mirror assemblies.

In addition, many mirror assemblies include lights, commonly referred to as puddle or approach lights. These lights illuminate the ground as well as the side of the motor vehicle allowing a person that is approaching the motor vehicle to see the ground and the side of the motor vehicle. Having the light emitted by the approach light on the ground and the motor vehicle, the operator avoids stepping in a puddle or running into the vehicle, damaging its finish. U.S. Pat. No. 5,017,903, issued to Krippelz on May 21, 1991, discloses an emergency light that illuminates the ground disposed adjacent the motor vehicle. This reference discloses an invention that only illuminates the ground and does not illuminate the side of the motor vehicle. In addition, the lighting unit in this reference is housed within the mirror housing. If this invention were to be incorporated into a telescoping mirror assembly, the pattern and location of the light will vary significantly. More specifically, the light that is illuminating only the ground will move away from the motor vehicle when the mirror assembly is extended out to its outermost position. This is an effect that is not desired because the portion of the ground that is illuminated will be further from the motor vehicle rendering the portion of the ground disposed between the motor vehicle and the illuminated portion of the ground in a condition less than desired due the poor visibility thereof.

### SUMMARY OF THE INVENTION

A side mirror assembly for a motor vehicle includes a base that is fixedly secured to the motor vehicle. A structural member is secured to the base. The structural member extends between a base end and a distal end. A mirror housing defining a mirror opening is operatively connected to the structural member. A mirror is mounted within the mirror housing and exposed through the mirror opening for an operator of a motor vehicle to view rearward of the motor vehicle without turning completely around. An approach light is fixedly secured to the structural member to emit visible light downwardly therefrom.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a perspective view of one embodiment of the invention secured to a motor vehicle, shown partially cut away;

FIG. 2 is a bottom view of one embodiment of the invention secured to a motor vehicle, shown in cross-section, of a side mirror assembly incorporating the invention; and

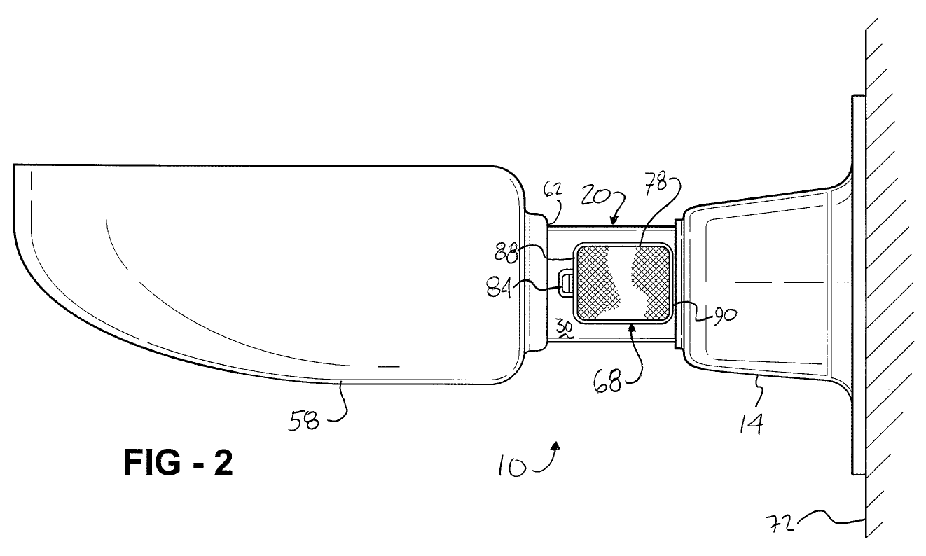

FIG. 3 is a side view, partially cut away, of the invention.

### DETAILED DESCRIPTION OF PREFERRED EMBODIMENT

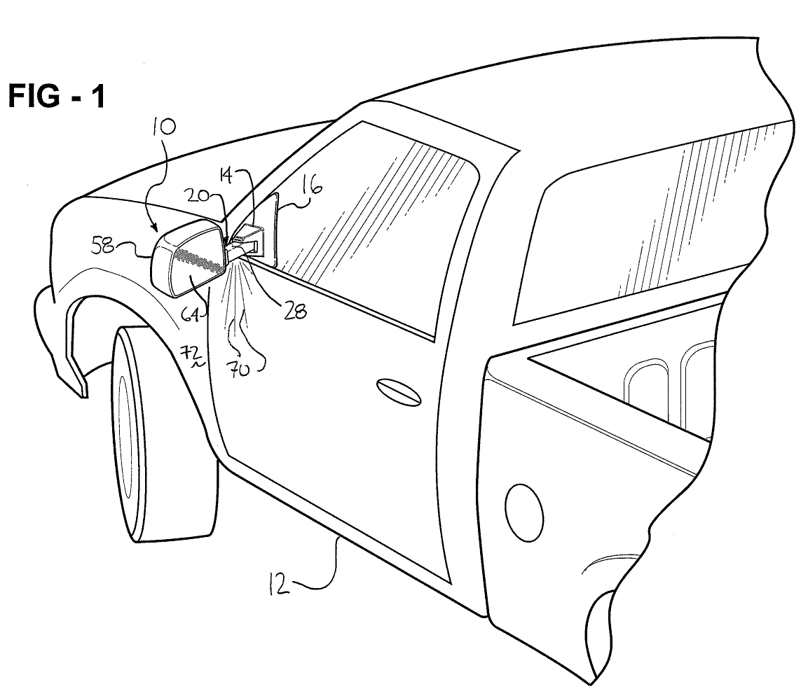

Referring to FIG. 1, one embodiment of the invention is generally indicated at 10. The invention is a side mirror assembly 10. The side mirror assembly 10 is fixedly secured to a motor vehicle 12. While the side mirror assembly 10 is shown as a side mirror assembly fixedly secured to a driver side of a motor vehicle 12 it should be appreciated by those skilled in the art that the side mirror assembly 10 may also be used on the passenger side of the motor vehicle 12.

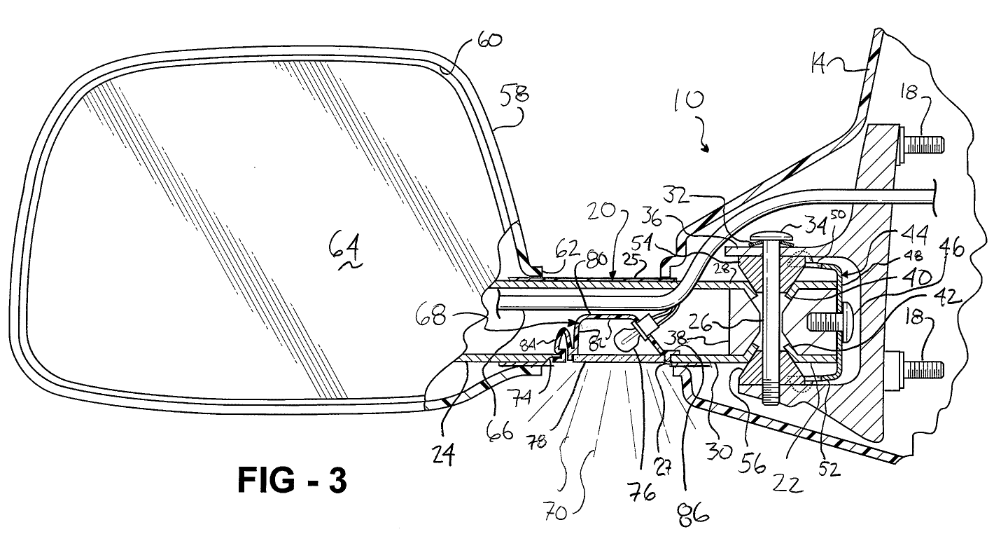

The side mirror assembly includes a base 14 which is fixedly secured to the motor vehicle 12. The base 14 may or may not include a plate 16 commonly referred to as a sail. The base 14 is fixedly secured to the motor vehicle 12 with a plurality of bolts 18, best shown in FIG. 3. The base 14 will be discussed in greater detail subsequently.

The side mirror assembly 10 also includes a structural member, generally shown at 20, that is pivotably secured to the base 14. While the structural member may be any elongated article, the preferred embodiment incorporates a tube as the structural member 20. The tube 20 extends between a base end 22 and a distal end 24. In the embodiment shown, the tube 20 has a square cross-section. It should be appreciated by those skilled in the art that the cross-section of the tube 20 may vary from a square cross-section and may include a non-closed cross section. It should also be appreciated that the tube 20 may be fixedly secured with respect to the base 14 and the motor vehicle 12 such that it does not pivot away from and toward the motor vehicle 12. The side mirror assembly 10 may include a sleeve 25 (FIG. 3) for the structural member 20 to enhance the aesthetics of the side mirror assembly 10 with decreasing costs by avoiding finishing steps to the structural member 20. The sleeve 25 defines a sleeve opening 27.

Referring to FIG. 3, the base end 22 of the tube 20 is secured to the base 14 using a pivot bolt 26. The pivot bolt 26 extends through two side of the tube 20. In the embodiment shown, the pivot bolt 26 extends through an upper tube side 28 and a lower tube side 30. The pivot bolt 26 allows the tube 20 to pivot through a plane that is generally parallel with ground (not shown). A Belleville washer 32 applies a force between a head 34 of the pivot bolt 26 and a base flange 36.

The base end 22 of the tube 20 includes base plug 38, which extends through the interior portion of the base end 22 of the tube 20. The base plug 38 is inserted into the tube 20 prior to the finishing of the tube 20 once the base plug is in place inside the tube 20, the tube 20 is swaged resulting in the creation of at least one frustoconical portion 40. In the embodiment shown in FIG. 3, there are two frustoconical portions 40, 42 having angled surfaces. The pivot bolt 26 extends through two holes in the base 14, each within one of the upper 28 and lower 32 tube sides.

A detent spring 44 provides a retention force against the tube 20 preventing the tube 20 from pivoting unless a force is applied to the distal end 24 of the tube 20 with sufficient force to overcome the force created by the detent spring 44. The detent spring 44 is secured to the base plug 38 with a plug bolt 46. Forces great enough to overcome the detent spring 44 include forces created by an individual trying the rotate the tube 20 toward and away from the motor vehicle 12 and situations where an accident may be occurring forcing the tube 20 to move with respect to the base 14. The detent spring 44 includes a primary portion 48 that extends around the base end 22 of the tube 20. The detent spring 44 has two ends 50, 52 which extend toward the pivot bolt 26. Friction cones 54, 56 extend into the frustoconical portions 40, 42. The friction cones 54, 56 are fabricated from a plastic material. It should be appreciated by those skilled in the art that other pivotal mechanisms may be used by a side mirror that includes the invention disclosed here.

The side mirror assembly 10 also includes a mirror housing 58. The mirror housing 58 defines a mirror opening 60 and a connection point for the structural member 20 to be received thereby to secure the mirror housing 58 thereto. In the embodiment shown, the connection point is a tube opening 62. The mirror housing 58 receives the distal end 24 and a portion of the tube 20 disposed adjacent the distal end 24 through the tube opening 62. A mirror 64 is mounted within the mirror housing 58. The mirror 64 is exposed through the mirror opening 60 for an operator of the motor vehicle 12 to view rearward of the motor vehicle 12 without turning completely around. More specifically, the mirror 64 allows the operator of the motor vehicle 12 to quickly see objects in space behind the motor vehicle 12 without have to turn completely around to remove one's vision from the direction in which the motor vehicle 12 is traveling.

The mirror 64 is mounted within the mirror housing 58 using a mirror mount (not shown) that includes a plate support to which the mirror 64 is directly secured. The plate support is pivotal to facilitate directing the mirror 64 to the proper orientation to allow the operator the best possible rearview of the motor vehicle 12.

The side mirror assembly 12 telescopes between a retracted position and an extended position. The telescoping mechanism may be driven by motor or it may be performed manually. A discussion of a telescoping mechanism is disclosed in U.S. patent application having application Ser. No. 11/763,601, the Assignee of which is the Assignee of this patent application, which is hereby incorporated by reference.

The side mirror assembly 10 includes a wire harness 66. The wire harness 66 provides electrical power to the side mirror assembly 10 allowing the side mirror assembly 10 to includes features such as turn signals, heating elements, and motors to move the mirror 64 and/or the mirror housing 58.

The side mirror assembly 10 includes an approach light, generally shown at 68. The approach light 68 is secured in relation to the tube 20 to emit visible light, graphically represented by rays 70 in FIGS. 1 and 3 downwardly. The approach light 68 is designed to shine light downwardly when activated across the ground and a side 72 of the motor vehicle 12. The approach light 68 is activated when a user of the motor vehicle 12 unlocks or locks the motor vehicle 12 using a button on a key fob (neither shown) of the motor vehicle 12. The light source 76 receives its power from the power source of the motor vehicle 12 through the wire harness 66. In embodiments where a sleeve 25 (shown in FIG. 3 only) is used over the structural member 20, the approach light 68 may be secured thereto. Otherwise, it is secured to the structural member 20.

The tube 20 defines a port 74 for receiving the approach light 68 therein. The port 74 extends between the base end 22 and the portion of the tube 20 adjacent the distal end 24 that is selectively covered by the mirror housing 58. More specifically, the approach light 68 is secured to the tube 20 in a port 74 that does not get covered by the mirror housing 58, regardless of whether the mirror housing 58 is in its extended or fully retracted positions.

The approach light 68 includes a light source 76 for emitting the visible light 70 therefrom. The light source may be an incandescent bulb or an LED. A lens 78 is fixedly secured to the approach light 68 and directs the visible light 70 emitted from the light source 76. It may be appreciated by those skilled in the art that the lens 78 may be designed to diffuse the light generally over a desired area. Alternatively, the lens 78 may specifically focus light to direct the light to a preferred area.

The approach light 68 includes a housing 80 that includes a plurality of walls 82. The plurality of walls 82 are planar reflectors. More specifically, the plurality of walls 82 extend through single non-curved planes. A portion of one of the walls 82 or a portion of a few of the walls 82 may define a radius of curvature resulting in the particular walls 82 extending through curved planes. The housing 80 is, however, designed to have the majority of the reflectors be planar.

A portion of the housing 80 includes a snap fastener 84. The snap fastener 84 works in combination with a flange 86 to secure the housing 80 within the tube opening 62 to the tube 20. The snap fastener 84 and the flange 86 are on opposite sides of the housing 80. In the embodiment shown in the Figures, the snap fastener 84 is disposed adjacent an outboard side 88 of the housing 80, whereas the flange 86 is fixedly secured to an inboard side 90 thereof. It should be appreciated by those skilled in the art that other fasteners may be used to removably secure the housing 80 to the side mirror assembly 10 such that the light source 76 may be maintained by removal of the housing 80 to access the light source 76.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

What is claimed:

1. A side mirror assembly for a motor vehicle, said side mirror assembly comprising:
a base fixedly secured to the motor vehicle;
a structural member secured to said base, said structural member extending between a base end and a distal end;
a mirror housing defining a mirror opening, said mirror housing secured to said distal end;
a mirror mounted within said mirror housing and exposed through said mirror opening for an operator of the motor vehicle to view rearward of the motor vehicle without turning completely around; and
an approach light secured in relation to said structural member to emit visible light downwardly.

2. A side mirror assembly as set forth in claim 1 wherein said approach light is secured to said structural member.

3. A side mirror assembly as set forth in claim 1 including a sleeve to cover said structural member.

4. A side mirror assembly as set forth in claim 3 wherein said sleeve defines a sleeve opening.

5. A side mirror assembly as set forth in claim 4 wherein said approach light is secured to said sleeve within said sleeve opening.

6. A side mirror assembly as set forth in claim 2 wherein said structural member is a tube.

7. A side mirror assembly as set forth in claim 6 including a sleeve to cover said tube.

8. A side mirror assembly as set forth in claim 7 said mirror housing defines a tube opening to receive said distal end and a portion of said tube adjacent said distal end through said tube opening.

9. A side mirror assembly as set forth in claim 8 wherein said tube defines a port for receiving said approach light therein.

10. A side mirror assembly as set forth in claim 9 wherein said port extends between said base end and said portion of said tube adjacent said distal end that is selectively covered by said mirror housing.

11. A side mirror assembly as set forth in claim 10 wherein said approach light includes a light source for emitting visible light therefrom.

12. A side mirror assembly as set forth in claim 11 wherein said approach light includes a lens for directing said visible light emitted from said light source.

13. A side mirror assembly for a motor vehicle, said side mirror assembly comprising:
a base fixedly secured to the motor vehicle;
a tube secured to said base, said tube extending between a base end and a distal end;
a mirror housing defining a mirror opening and a tube opening, said mirror housing receiving said distal end and a portion of said tube adjacent said distal end through said tube opening;
a mirror mounted within said mirror housing and exposed through said mirror opening for an operator of the motor vehicle to view rearward of the motor vehicle without turning completely around; and
an approach light secured to said tube to emit visible light downwardly, said approach light including a housing having a plurality of planar reflectors.

14. A side mirror assembly as set forth in claim 13 wherein said tube defines a port for receiving said approach light therein.

15. A side mirror assembly as set forth in claim 14 wherein said housing includes a snap fastener to secure said housing in said tube substantially inside said tube.

16. A side mirror assembly as set forth in claim 15 wherein said housing defines a flange for positioning said housing with respect to said tube to secure said housing thereto.

17. A side mirror assembly as set forth in claim 16 wherein said port extends between said base end and said portion of said tube adjacent said distal end that is selectively covered by said mirror housing.

18. A side mirror assembly as set forth in claim 17 wherein said approach light includes a light source for emitting visible light therefrom.

19. A side mirror assembly as set forth in claim 18 wherein said approach light includes a lens for directing said visible light emitted from said light source.
